(19) United States
(12) Patent Application Publication
(10) Pub. No.: US 2024/0127130 A1
(43) Pub. Date: Apr. 18, 2024

(54) Collaborative Karaoke System, Method, and Application

(71) Applicant: Donald Pollman, Torrance, CA (US)

(72) Inventor: Donald Pollman, Torrance, CA (US)

(21) Appl. No.: 18/353,482

(22) Filed: Jul. 17, 2023

Related U.S. Application Data
(60) Provisional application No. 63/416,969, filed on Oct. 18, 2022.

(51) Int. Cl. G06Q 10/02; G06Q 50/00

(52) U.S. Cl. CPC G06Q 10/02; G06Q 50/01

(57) ABSTRACT

A collaborative karaoke system that enables users to participate in karaoke sessions accompanied by live instruments. The system provides a mobile application installed on a user's device for providing interfaces for selecting venues, genres of music, and desired instruments. Users can connect and chat (i.e., chatroom) with other individuals registered in the system for collaboration and playing music in a karaoke setting. The system also includes a server system that includes an application server, a recommendation module, a user profile database, and a karaoke venue database, and the system facilitates venue recommendations based on user profiles and preferences.

### CROSS-REFERENCE TO RELATED APPLICATION

The present application claims priority to, and the benefit of, U.S. Provisional Application No. 63/416,969, which was filed on Oct. 18, 2022, and is incorporated herein by reference in its entirety.

### FIELD OF THE INVENTION

The present invention generally relates to the field of karaoke scheduling systems. More specifically, the present invention relates to a novel system that provides a mobile application for selecting karaoke venues, connecting with other users, and receiving recommendations for karaoke venues. The application enables people to chat with each other and to rent out a karaoke venue. Accordingly, the present disclosure makes specific reference thereto. Nonetheless, it is to be appreciated that aspects of the present invention are also equally applicable to other like applications, devices, and methods of manufacture.

### BACKGROUND

By way of background, many people like playing musical instruments and enjoying karaoke. Conventional karaoke enables people to sing songs but not let people play and collaborate with musical instruments. More specifically, traditional karaoke setups primarily focus on singing, often excluding the use of live instruments. This limitation prevents individuals who enjoy playing instruments from fully expressing their musical talents and collaborating with others.

Commonly, high prices of musical instruments also act as a barrier for individuals who want to own and play instruments regularly. This expense can also limit their ability to fully enjoy karaoke sessions that involve playing instruments. Karaoke enthusiasts who own instruments may find it inconvenient to carry their instruments to karaoke bars. Instruments can be bulky and require special care during transportation.

Individuals interested in collaborative karaoke sessions face challenges in finding musician friends. Such people generally do not have a network of like-minded musicians or people with similar musical interests who can accompany their singing with instruments. Finding suitable karaoke venues that align with personal preferences can also be challenging. Without efficient means of discovering preferred venues, individuals may struggle to find karaoke establishments that cater to their desired experiences, leading to dissatisfaction and limited enjoyment. People desire a system and method that can overcome the problems associated with conventional karaoke setups for music enthusiasts.

Therefore, there exists a long felt need in the art for a system that enables music enthusiasts to connect with each other to participate in karaoke. There is also a long felt need in the art for a system that enables people to find karaoke venues of their preferences. Additionally, there is a long felt need in the art for a mobile application that enables users to search and select karaoke venues for booking at desired time slots. Moreover, there is a long felt need in the art for a mobile application that enables people to find other people interested in playing music together and rent out a venue. Further, there is a long felt need in the art for a system that enables people to select venues, times, and instruments to participate with other users. Finally, there is a long felt need in the art for a system that obviates users from carrying musical instruments to a karaoke venue while offering a way for people to enjoy karaoke and music together.

The subject matter disclosed and claimed herein, in one embodiment thereof, comprises a collaborative karaoke system for providing users with the opportunity to participate in karaoke sessions accompanied by live instruments. The system features a mobile application installed in a mobile device, the mobile application is configured for providing user interfaces for interacting with the system, a server system connected to the mobile application via a communication network, the server system comprising an application server, a recommendation module configured to provide karaoke venue recommendations based on user profiles and preferences, wherein the application enables users to select karaoke venues for performing karaoke with musical instruments provided at the venue and connect with other people for collaboration for the karaoke.

In this manner, the collaborative karaoke system and the mobile application of the present invention accomplish all of the forgoing objectives and provide users with a software application designed to connect musicians to participate in karaoke together. The system enables users to select venues, times, and instruments to participate with other users via the mobile application. Using the system, musicians can come to a karaoke establishment with other like-minded individuals to play instruments and sing songs together wherein the instruments can be provided by the venue.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a collaborative karaoke system for providing users with the opportunity to participate in karaoke sessions accompanied by live instruments. The system further comprising a mobile application installed in a mobile device, the mobile application is configured for providing user interfaces for interacting with the system, a server system connected to the mobile application via a communication network, the server system comprising an application server configured for processing user requests, user authentication, and session management, a recommendation module configured to analyze user data from a user profile database and provides karaoke venue recommendations based on user profiles and preferences, wherein the application enables users to select karaoke venues for performing karaoke with musical instruments provided at the venue.

In yet another embodiment, a method for facilitating karaoke sessions with instruments among a plurality of users at a venue is described. The method is performed using a mobile application installed on a mobile device and comprising the steps of launching the mobile application on the mobile device by the user, receiving a desired location for finding karaoke venues from a list or drop-down menu, receiving a preferred genre of music for the karaoke session, receiving selection of one or more musical instruments including options such as guitars, keyboards, drums, and more, displaying a list of venues matching the user's preferences, including details such as name, location, venue photos, ratings, and available slots, receiving selection of at least one karaoke venue for the session, receiving selection of one or more slots at the selected venue for the karaoke session, and receiving booking of the selected venue for the karaoke session, with instruments provided by the venue.

In a further embodiment, a user connects with the other registered users of the system and chats using an integrated chat module of the mobile application.

In a further embodiment, location of the mobile device is detected using a GPS sensor of the mobile device for displaying nearby karaoke venue locations.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a schematic view of a collaborative karaoke system of the present invention in accordance with the disclosed architecture;

FIG. 2 illustrates a flow diagram depicting a process of recommending different karaoke venue locations to a user by the collaborative karaoke system of the present invention in accordance with the disclosed architecture;

FIGS. 3A and 3B illustrate a flow diagram depicting a process of selecting and booking a karaoke venue as per preferences given by a user in accordance with the disclosed architecture;

FIG. 4 illustrates a flow diagram depicting a process of a user connecting with likeminded people for a karaoke session using the mobile application and the karaoke collaboration system of the present invention in accordance with the disclosed architecture;

FIG. 5 is a flow diagram depicting another process of selecting a venue for a karaoke session by a user using the mobile application in accordance with the disclosed architecture;

FIG. 6 illustrates an exemplary user interface displayed by the mobile application for displaying songs of a specific genre for users in accordance with the disclosed architecture; and

FIG. 7 illustrates an exemplary news feed displayed by the mobile application for a user in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for a system that enables music enthusiasts to connect with each other to participate in karaoke. There is also a long felt need in the art for a system that enables people to find karaoke venues of their preferences. Additionally, there is a long felt need in the art for a mobile application that enables users to search and select karaoke venues for booking at desired time slots. Moreover, there is a long felt need in the art for a mobile application that enables people to find other people interested in playing music together and rent out a venue. Further, there is a long felt need in the art of a system that enables people to select venues, times, and instruments to participate with other users. Finally, there is a long felt need in the art for a system that obviates users to carry musical instruments to a karaoke venue while offering a way for people to enjoy karaoke and music together.

The present invention, in one exemplary embodiment, is a method for facilitating karaoke sessions with instruments among a plurality of users at a venue. The method is performed using a mobile application installed on a mobile device and comprising the steps of launching the mobile application on the mobile device by the user, receiving a desired location for finding karaoke venues from a list or drop-down menu, receiving a preferred genre of music for the karaoke session, receiving selection of one or more musical instruments including options such as guitars, keyboards, drums, and more, displaying a list of venues matching the user's preferences, receiving selection of at least one karaoke venue for the session, and receiving selection of one or more slots at the selected venue for the karaoke session.

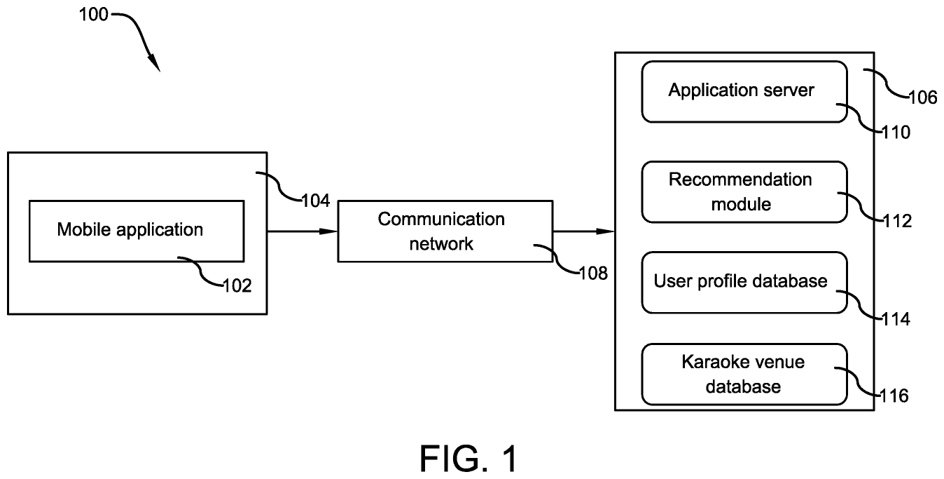

Referring initially to the drawings, FIG. 1 illustrates a schematic view of collaborative karaoke system of the present invention in accordance with the disclosed architecture. The collaborative karaoke system 100 of the present invention is designed to provide users such as music lovers with the opportunity to participate in karaoke sessions accompanied by live instruments. The system 100 is a computer-implemented system and can be used by a plurality of users for collaborating with like-minded people to collaborate for karaoke. More specifically, the system 100 includes a mobile application 102 installed in a mobile device 104. The mobile application 102 provides a plurality of user interfaces, enabling users to interact with the system 100. Users can access various features of the application 102, such as selecting venues, choosing instruments, coordinating songs with other users, and managing their profiles and preferences as described in detail later in the disclosure. The mobile application 102 can be downloaded from a playstore such as AppStore or Google PlayStore. The mobile device 104 can be any handheld smartphone, mobile phone, smartwatch, PDA, tablet, laptop, desktop computer and the like.

The mobile application 102 is connected to a server system 106 via a communication network 108 which can be a public network such as the Internet or can also be a private network accessible using a Virtual Private Network (VPN). The server system 106 can be a centralized server or can be in the form of distributed or cloud server. The server system 106 includes an application server 110 configured for processing user requests received from the mobile application 102. Further, the application server 100 also performs user authentication of users and session management of the application 102. The application server 110 can be one or more of web application server, Java application server, .NET application server, Node.js application server and more.

A recommendation module 112 is included in the server system 106 for providing karaoke venue recommendations to users based on their profiles and preferences. The recommendation module 112 is configured to analyze user data from the user profile database 114 and applies machine learning algorithms to suggest venues that align with users' musical interests, location, availability, and other parameters stored in the user profile database 114. The recommendation module 112 helps users discover suitable karaoke venues that suit their preferences.

The user profile database 114 is configured to store profiles and preferences of the application users. The user profile database 114 stores and selectively sorts information including but not limited to user demographics, musical preferences, instrument preferences, preferred genres, past karaoke activities, and other relevant data. The data stored in the user profile database 114 is provided by the users during creation of their profiles using the mobile application 102. The database 114 enables the system 100 to personalize the user experience and enables the recommendation module 112 to make informed venue suggestions based on user profiles.

The karaoke venue database 116 stores and selectively sorts information about the available venues where karaoke sessions with instruments take place. The karaoke venue database 116 can include details about each venue, such as the name, location, available instruments, time slots, capacity, and any other relevant information. The database 116 provides information that enables users to browse and select venues that match their requirements.

The databases 114, 116 can be one or more types of relational database, NoSQL database, columnar database, object storage, block storage and more. It should be noted that the application server 110 is selected based on a plurality of parameters including the programming language, scalability requirements, deployment environment, and specific features and capabilities needed for the “karaoke with Instruments” mobile application 102.

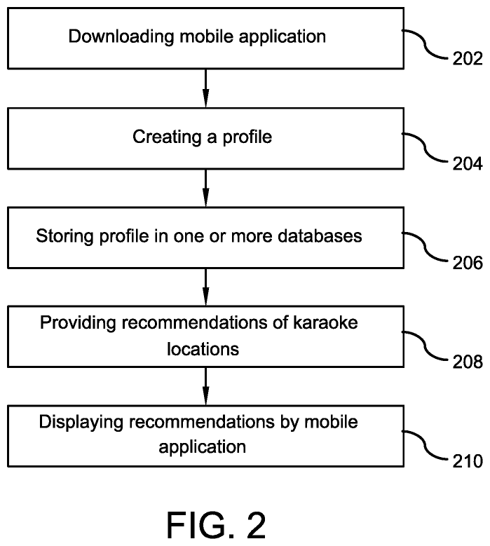

FIG. 2 illustrates a flow diagram depicting a process of recommending different karaoke venue locations to a user by the collaborative karaoke system of the present invention in accordance with the disclosed architecture. Initially, a user downloads the mobile application 102 from an app store (Step 202). Once downloaded, the mobile application 102 is installed in the mobile device 104 and is ready to use to access functionalities provided by the system 100. Then, for the first time use, the user is required to create a user profile by providing information such as name, age, location, and other relevant details including musical preferences, favorite genres, musical instruments the user can play, and any other relevant information that helps personalize the user's experience within the application (Step 204).

The user profile information entered by the user is then stored in the user profile database 114 (Step 206). The application server 110 acts as an intermediary between the mobile application 102 and the database 114 and receives the profile data and stores same in the user profile database 114. The recommendation module 112 utilizes the stored user profile information from the user profile database 114 to suggest karaoke venue locations that align with the users' preferences (Step 208). The recommendation module 112 can take into consideration profile factors such as preferred genres, instrument choices, location, availability, past activities, and more. Finally, the mobile application 102 receives the recommended venue locations from the recommendation module 112 and displays the recommendations in the form of a list and in the form of a digital map enabling users to browse through the recommendations, view additional information about each venue, and make informed decisions (Step 210).

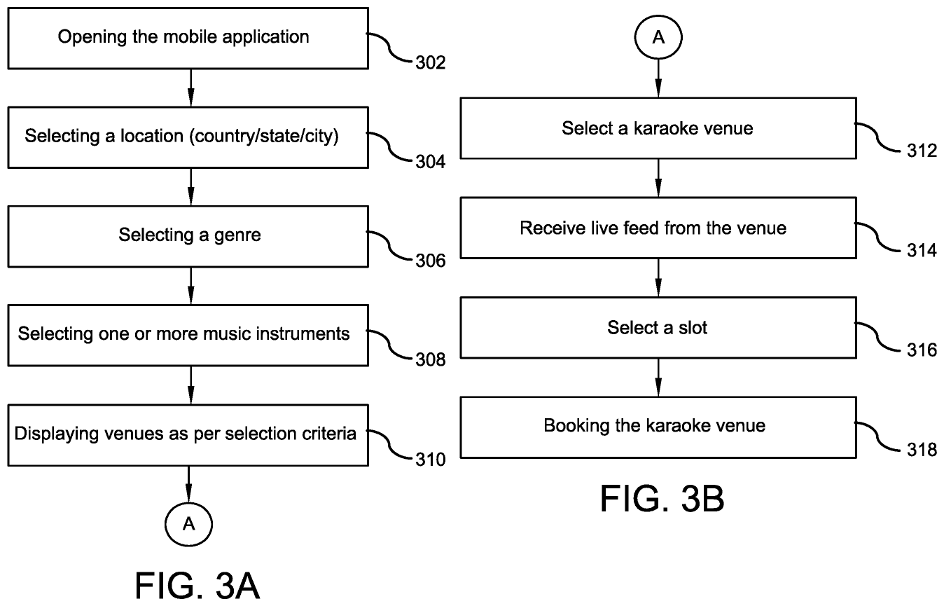

FIGS. 3A and 3B illustrate a flow diagram depicting a process of selecting and booking a karaoke venue as per preferences given by user in accordance with the disclosed architecture. Initially, a user launches the “karaoke with Instruments” mobile application 102 on the mobile device 104 such as by tapping an icon of the application 102 (Step 302). Then, the user selects the desired location for finding karaoke venues and the location can be a country, state, and city from a list or a drop down menu (Step 304).

Then, the user can choose a preferred genre of music for the karaoke session (Step 306). The application 102 can present a list of genres or can provide a search option or a drop down menu listing different music genres. The user can pick at least one genre that suits their musical taste or explore different options.

Thereafter, the user selects one or more musical instruments based on their proficiency and interest and musical instruments can include guitars, keyboards, drums, and more (Step 308). The selected musical instruments are chosen by the user to play during the karaoke session. Based on the selection criteria chosen in steps 304, 306, 308, the application 102 displays a list of venues matching the user's preferences (Step 310). The venues can be displayed as cards, a grid, or in a list format. Further, each venue can include details like name, location, venue photos, ratings, available slots, and more.

As illustrated in FIG. 3B, the user, then selects at least one karaoke venue for a karaoke session (Step 312). It should be noted that details such as venue descriptions, user reviews, ratings, and available time slots help in making the user an informed decision. The system 100 enables the users to view a live video of the selected venue before booking the venue which is displayed by the mobile application (Step 314). After reviewing the live video, the user can select one or more slots at the selected venue for the karaoke session (Step 316). Finally, the venue is booked for organizing the karaoke session wherein the instruments can be provided by the venue (Step 318). The payment for the booking of the venue can be made using a payment gateway provided by the mobile application 102 or can also be made at the venue depending on the preferences of the user.

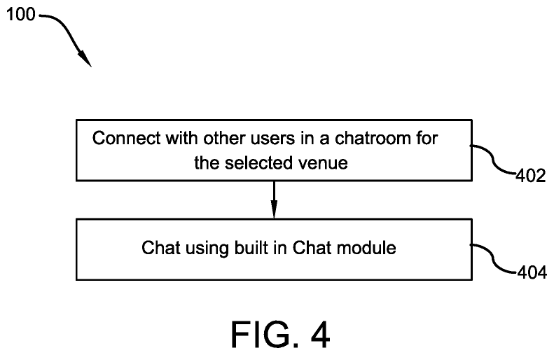

FIG. 4 illustrates a flow diagram depicting a process of a user connecting with likeminded people for a karaoke session using the mobile application 102 and the karaoke collaboration system of the present invention in accordance with the disclosed architecture. Initially, for a selected venue, a user connects with other users registered in the system included in a chatroom wherein the chatroom is designed for the selected venue (Step 402). The system can include a plurality of chatrooms based on types of genres, for individual venues, based on types of instruments and more. A user can select a chatroom based on the preferences. It should be noted that in some of the embodiments, some of the chatrooms can be private and only users having authorization such as successful payment for a venue can access the chatrooms.

Then, the user can start chat using a built-in chat module in the application 102 with the connected users for discussing about a karaoke session (Step 404). The chats can be public or private and can be stored locally in the mobile device 104.

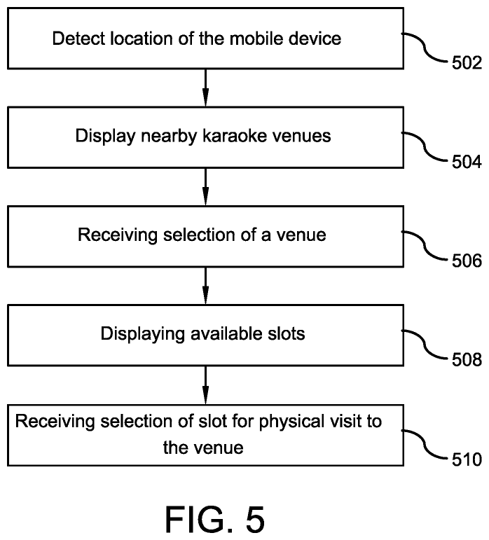

FIG. 5 is a flow diagram depicting another process of selecting a venue for a karaoke session by a user using the mobile application 102 in accordance with the disclosed architecture. Initially, the location of the mobile device 104 in which the mobile application 102 is installed is detected using integrated GPS sensor of the mobile device 104 (Step 502). Based on the detected location, nearby karaoke venues registered with the system 100 and stored in the karaoke venue database 116 are displayed on the mobile application 102 (Step 504). Thereafter, a selection of a venue is received from the user wherein the selection can be based on the parameters described in FIG. 3A (Step 506).

The mobile application 102, then displays a plurality of available slots distributed across multiple dates available at the selected venue (Step 508). The slots can be displayed in a calendar display or can be in the form of a list for selection by the user. Finally, one or more slots are selected by the user for organizing or participating in a karaoke session wherein the musical instruments can be provided by the venue (Step 510).

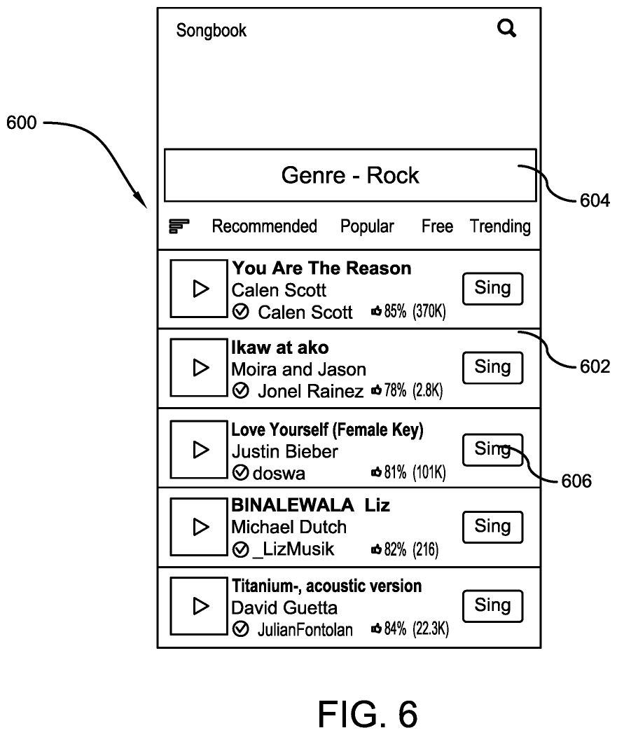

FIG. 6 illustrates an exemplary user interface displayed by the mobile application for displaying songs of a specific genre for users in accordance with the disclosed architecture. As illustrated, the user interface 600 of the application 102 displays a list 602 of songs/music of a specific genre 604 selected by a user. The interface 600 is also configured to display lyrics of the selected song upon tapping “Sing” icon 606.

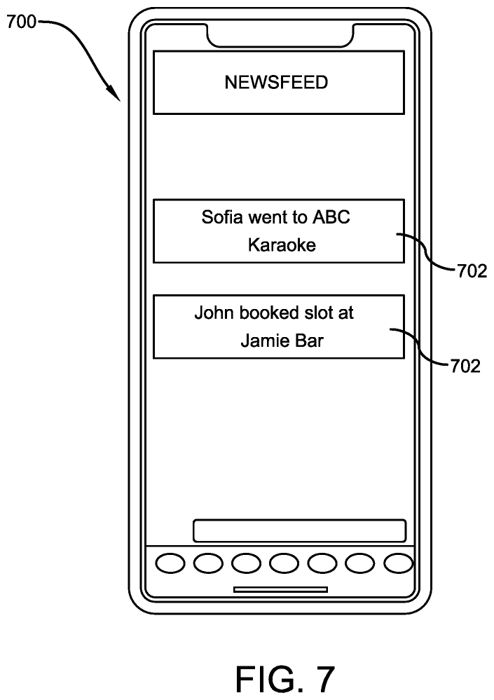

FIG. 7 illustrates an exemplary news feed displayed by the mobile application for a user in accordance with the disclosed architecture. The mobile application 102 is configured to display a newsfeed 700 displaying a plurality of real time news and notifications 702 of connections of the user and about the preferred venues and events. As illustrated, the notifications 702 provide information about connections of the user, thereby enabling the user to make an informed decision about a karaoke session.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “collaborative karaoke system”, “karaoke collaboration system”, and “system” are interchangeable and refer to the collaborative karaoke system 100 of the present invention. Similarly, as used herein “mobile application”, “karaoke with instruments mobile application”, and “application” are interchangeable and refer to the karaoke with instruments mobile application 102 of the present invention.

Notwithstanding the forgoing, the karaoke collaboration system 100 of the present invention can be of any suitable size and configuration as is known in the art without affecting the overall concept of the invention, provided that it accomplishes the above stated objectives. One of ordinary skill in the art will appreciate that the karaoke collaboration system as shown in the FIGS. are for illustrative purposes only, and that many other configurations of the karaoke collaboration system are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A karaoke system for incorporating musical instruments, the karaoke system comprising:
a computer-implemented karaoke system including a mobile application, a communication network, and a server system for connecting a plurality of users;
wherein said mobile application provides a plurality of user interfaces on a plurality of mobile devices of said plurality of users to interact with said karaoke system;
wherein said mobile application having criteria features selected from a group consisting of a name, an age, a venue, a musical instrument, a song, another user, a user profile, a preference, a location, a musical interest, an availability, a user demographic, a musical preference, an instrument preference, a preferred genre, and a past karaoke activity to create a user profile;
wherein said server system having an application server for processing user requests received from said mobile application, further wherein said application server authenticates said plurality of users;
wherein said server system having a recommendation module;
wherein said recommendation module analyzes said criteria features of said plurality of users and provides venue recommendations to said plurality of users based on said user profile, said preference, said venue, said musical interest, said location, and said availability; and
further wherein said venue recommendations are chatrooms.

2. The karaoke system of claim 1, wherein said application server selected from a group consisting of a web application server, a Java application server, a .NET application server, and a Node.js application server.

3. The karaoke system of claim 2, wherein said communication network is selected from a group consisting of a public network such as the Internet or can also be a private network accessible using a Virtual Private Network (VPN).

4. The karaoke system of claim 3, wherein said server system is selected from a group consisting of a centralized server, a distributed server, and a cloud server.

5. The karaoke system of claim 4 further comprising a profile database for storing said user profiles and said preferences of said plurality of users.

6. The karaoke system of claim 5, wherein said profiles and said preferences of said plurality of users selected from the group consisting of a user demographic, a musical preference, an instrument preference, a preferred genre, and a past karaoke activity.

7. The karaoke system of claim 6, wherein said profile database is provided by said plurality of users when creating said user profiles using said mobile application.

8. The karaoke system of claim 7, wherein said venue recommendations further comprising a time slot and a capacity.

9. A method of locating karaoke locations incorporating musical instruments, the method comprising the following steps:
providing a computer-implemented karaoke system including a mobile application, a communication network, and a server system for connecting a plurality of users, wherein said mobile application provides a plurality of user interfaces on a plurality of mobile devices of said plurality of users to interact with said karaoke system;
creating a user profile by selecting criteria features with said mobile application from a group of criteria features consisting of a name, an age, a venue, a musical instrument, a song, another user, a user profile, a preference, a location, a musical interest, an availability, a user demographic, a musical preference, an instrument preference, a preferred genre, and a past karaoke activity;
processing user requests received from said mobile application with an application server;
authenticating said plurality of users with said application server;
analyzing said criteria features of said plurality of users with said recommendation module; and
providing karaoke said venue recommendations to said plurality of users with said recommendation module, wherein said venue recommendations based on said user profile, said preference, said musical interest, said location, and said availability.

10. The method of locating karaoke locations incorporating musical instruments of claim 9, wherein said application server selected from a group consisting of a web application server, a Java application server, a .NET application server, and a Node.js application server.

11. The method of locating karaoke locations incorporating musical instruments of claim 9, wherein said communication network is selected from a group consisting of a public network such as the Internet or can also be a private network accessible using a Virtual Private Network (VPN).

12. The method of locating karaoke locations incorporating musical instruments of claim 9, wherein said server system is selected from a group consisting of a centralized server, a distributed server, and a cloud server.

13. The method of locating karaoke locations incorporating musical instruments of claim 9, further comprising a step of storing said user profiles and said preferences of said plurality of users in a profile database.

14. The method of locating karaoke locations incorporating musical instruments of claim 13, wherein said user profiles and said preferences of said plurality of users selected from a group consisting of a user demographic, a musical preference, an instrument preference, a preferred genre, and a past karaoke activity.

15. The method of locating karaoke locations incorporating musical instruments of claim 14, wherein said profile database is provided by said plurality of users when creating said user profiles using said mobile application.

16. The method of locating karaoke locations incorporating musical instruments of claim 15, wherein said venue recommendations further including a time slot and a capacity, and further wherein said venue recommendations are chatrooms.

17. A method of locating karaoke locations incorporating musical instruments, the method comprising the steps of:
providing a computer-implemented karaoke system including a mobile application, a communication network, and a server system for connecting a plurality of users;
downloading said mobile application onto a plurality of mobile devices, wherein said mobile application provides a plurality of user interfaces on said plurality of mobile devices of said plurality of users to interact with said karaoke system;
creating a user profile by selecting criteria features with said mobile application from a group of criteria features consisting of a name, an age, a venue, a musical instrument, a song, another user, a user profile, a preference, a location, a musical interest, an availability, a user demographic, a musical preference, an instrument preference, a preferred genre, and a past karaoke activity
processing user requests received from said mobile application with an application server;
authenticating said plurality of users with said application server;
analyzing said user profiles of said plurality of users with said recommendation module; and
providing karaoke said venue recommendations to said plurality of users with said recommendation module, wherein said venue recommendations based on said user profile, said preference, said musical interest, said location, and said availability.

18. The method of locating karaoke locations incorporating musical instruments of claim 17, further comprising a step of storing said user profiles and said preferences of said plurality of users in a profile database.

19. The method of locating karaoke locations incorporating musical instruments of claim 17, further comprising a step of selecting and booking said venue recommendation, wherein said venue recommendation is a chatroom.

20. The method of locating karaoke locations incorporating musical instruments of claim 17, further comprising a step of selecting one or more musical instruments by the user to play during a karaoke session.
